(19) United States
(12) Patent Application Publication
(10) Pub. No.: US 2017/0004428 A1
(43) Pub. Date: Jan. 5, 2017

(54) EVENT ATTIRE RECOMMENDATION SYSTEM AND METHOD

(71) Applicant: International Business Machines Corporation, Armonk, NY (US)

(72) Inventors: Michael Desmond, White Plains, NY (US); Matous Havlena, Pardubikcy kraj (CZ); Stacy F. Hobson, Poughkeepsie, NY (US); Minkyong Kim, Scarsdale, NY (US); Sophia Krasikov, Katonah, NY (US); Ying Li, Mohegan Lake, NY (US); Robin Lougee, Yorktown Heights, NY (US); Valentina Salapura, Chappaqua, NY (US)

(21) Appl. No.: 14/939,200

(22) Filed: Nov. 12, 2015

Related U.S. Application Data
(60) Provisional application No. 62/186,656, filed on Jun. 30, 2015.

(51) Int. Cl. G06Q 10/06

(52) U.S. Cl. CPC G06Q 10/06311

(57) ABSTRACT

A method for generating event profiles comprises receiving source data in a processor, extracting an attire property from the source data, extracting an event attribute from the source data, associating the attire property with the event attribute, generating an event profile that includes the associated attire property and the event attribute, and saving the event profile in a memory.

### PRIORITY

This application is a Non-Provisional Application of U.S. Provisional Application Ser. No. 62/186,656, entitled “EVENT ATTIRE RECOMMENDATION SYSTEM AND METHOD”, filed Jun. 30, 2015, under 35 U.S.C. §119(e), which is incorporated herein by reference in its entirety.

### BACKGROUND

The present invention relates to personal planning and event planning.

Social event such as weddings, fundraising events, parties, political events and other events often have prescribed attire or socially acceptable attire. For example, appropriate dress a formal wedding ceremony in a cathedral is often different than appropriate dress for a casual wedding ceremony performed on a beach. At the formal wedding, the attendees may be expected to wear a dark wool suit and tie or a formal dress, while attendees at the casual ceremony on the beach may not wear suits or formal dresses.

### SUMMARY

According to an embodiment of the present invention, a method for generating event profiles comprises receiving source data in a processor, extracting an attire property from the source data, extracting an event attribute from the source data, associating the attire property with the event attribute, generating an event profile that includes the associated attire property and the event attribute, and saving the event profile in a memory.

According to another embodiment of the present invention, a method for providing attire recommendations comprises receiving an event description from a user, identifying an event profile corresponding to the event description, retrieving attire properties from the identified event profile, and outputting the retrieved attire properties to the user.

According to yet another embodiment of the present invention, a computer program product comprising a computer readable storage medium having program instructions embodied therewith, the program instructions executable by a processor to cause the processor to perform a method that comprises receiving source data in a processor, extracting an attire property from the source data, extracting an event attribute from the source data, associating the attire property with the event attribute, generating an event profile that includes the associated attire property and the event attribute, and saving the event profile in a memory.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary embodiment of a system.

FIG. 2 illustrates an exemplary method of operation of the system that generates an event profile for an event.

FIG. 3 illustrates an exemplary method of operation of the system that outputs attire properties to a user.

FIG. 4 illustrates another exemplary method of operation of the system of FIG. 1 that outputs object properties to a user.

### DETAILED DESCRIPTION

Determining the proper attire for an event can be difficult. The type of event, time, cultural association of the event, location, season, climate, age of the attendees, and weather are all factors that attendees often consider when choosing the proper attire. Other aesthetic and decorative considerations are also considered for events using similar criteria. For example, the choice of colors for table cloths and decorations such as flowers is often also determined by similar factors.

Often the invitations to the event do not offer sufficient information for attendees to make a satisfactory decision as to what attire a particular attendee should wear. The methods and systems described herein provide users with recommendations as to what attire should be worn at a particular event or what decorations should be used at a particular event.

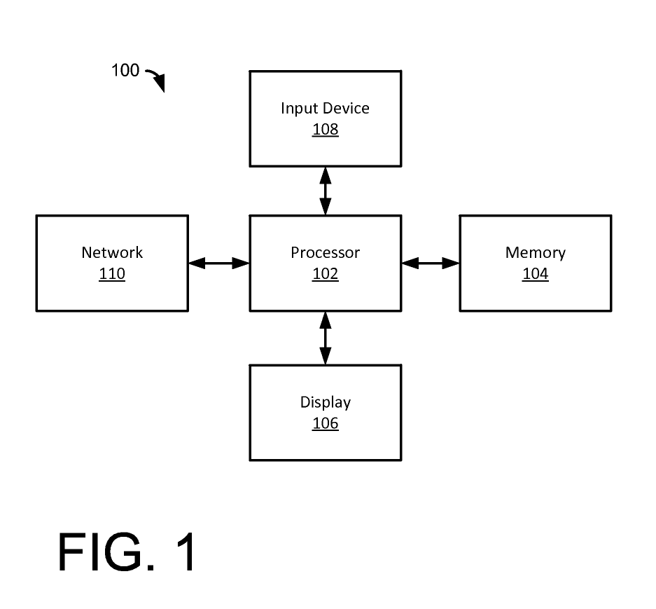

FIG. 1 illustrates an exemplary embodiment of a system 100. The system 100 includes a processor 102. The processor 102 is communicatively connected to a memory 104, a display 106, an input device 108, and a network 110. The processor 102 is communicatively connected to the memory 104, the display 106, the input device 108, and the network 110.

An event profile includes event data describing the event such as, for example, the type of event (e.g., birthday party, wedding, picnic, gala), time of the event, date of the event, day of the week of the event, geographic location of the event, whether the event is indoors or outdoors, the weather at the time of the event, cultural associations of the event, national associations of the event, gender of the participants, age of the participants and any other appropriate description of a particular event. Clothing and attire that is appropriate or recommended for the event is entered into the event profile. For example, a birthday party for a child that is held at a beach in Miami Fla. in December, may have an event profile that includes swimming attire for the participants, while a new year's party for adults that is held at an expensive hotel in Chicago Ill. in December, may have an event profile that includes evening wear and warm coats for the participants.

Event attributes may include any type of data about an event, for example, images, photographs, video, textual and non-textual descriptions of an event. The event attributes may be gathered from source data from any number of sources such as, for example, social media websites, website searches, or databases. Metadata or other data associated with the source data may be used to determine the context of the event attributes. For example, for an image having associated metadata that labels the image as a birthday party, the processor 102 (of FIG. 1) would associate data gathered from the image with birthday parties. Often images have other associated metadata such as, for example, a time, geographical location, and an identity of the persons or objects in the image. The time and geographical location associated with the image may be used to search for the local weather that was occurring when the image was taken. The image is then processed by the processor 102 using image processing algorithms and logic to determine attributes or properties of the attire that is worn by the individuals in the image. The properties may include for example, style of dress, color palettes, shoe styles, patterns and texture, accessories, item components such as jackets, coats, ties, dresses, lengths of dresses, hats, sunglasses, and the relative formality of the particular attire of the persons in the image. The attire properties generated from processing the image are associated with the event attributes in the event profile. Though the example above includes the use of an image, event data may be generated from any type of data such as, for example, video or textual or non-textual data formats.

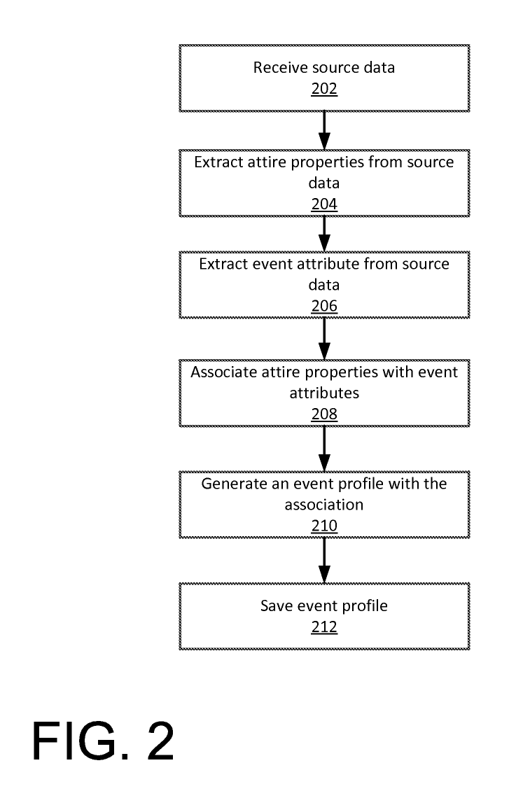

FIG. 2 illustrates an exemplary method of operation of the system 100 (of FIG. 1), which generates an event profile for an event using a deep-learning based approach to train a model. In block 202, the processor 102 receives source data. The source data may include any type of data that may associate attire with an event. For example, source data may be found using search engines, social networking sites, or could be manually input by a user. Source data may include images such as photographs or videos that show people at an event, event invitations that include dress codes, or any other data that has an implicit or explicit association between attire and a particular event or type of event.

In block 204, the processor 102 processes the source data and extracts attire properties of the source data. Processing the source data may include any number of methods for processing data. For example, images may be processed by the processor 102 (of FIG. 1) to identify the attire worn by the people at the event using methods for identifying or determining a description of attire a person in an image is wearing. Such methods are similar to facial recognition methods, and are tailored to recognize attire in a similar manner as recognizing faces.

In block 206, event attributes are extracted from the source data. Some images may include metadata or other contextual data that may indicate a geographical location of where the image was taken, a time or date the image was taken, or other information such as a description of the event, for example, a tag or comment associated with the image may include a title such as “birthday party” or “wedding.” Thus, in block 206, relevant metadata may be extracted from the source data.

In block 208 the attire properties are associated with the event attributes. Thus, a database or databank that stores attire properties associated with event attributes is stored in the memory 104. In block 210 an event profile is generated that includes the event attributes data and the associated attire properties data. The event profile is saved in the memory 104 in block 212. The event profiles in the memory 104 provide an association between events and attire. Thus, event profiles may include a description of the event, that may include one or more words such as “birthday party,” “wedding,” “fundraiser.” Event profiles, may also include, a time and date of the event, and geographic location, geographic location, or event theme, which may be used to further classify an event. Event profiles may also include a venue or description of the venue where the event occurs. For example, a casual family restaurant may be distinguished from a formal restaurant. The event profiles include clothing or attire that is associated with the event attributes in the event profile. Thus, the event profiles provide details about an event and attire worn at the event.

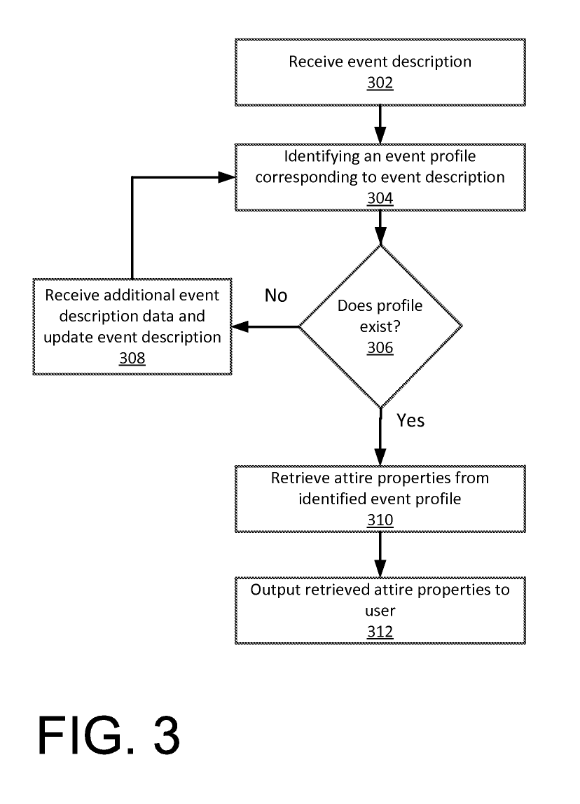

FIG. 3 illustrates an exemplary method of operation of the system 100 (of FIG. 1) that outputs attire properties as recommendations to a user for an event. In this regard, in block 302, an event description is received by the processor 102. The event description may include, for example, a description of the type of event, the time, and location of the event. The event description may be, for example, entered by the user using the input device 108 or another user device connected to the processor 102 via the network 110. In block 304, the processor 102 searches for an event profile in the memory 104 that corresponds, matches, or is similar to the received event description. Various search algorithms or methods may be used to identify one or more event profiles that match the event description. In some exemplary embodiments, in block 306, the processor may determine whether an event profile exits. If no, the processor 102 may request additional event description data from the user, and may update the event description in block 308. If yes, the clothing properties are retrieved from the event profile 310. In block 312, the clothing properties in the identified event profile are output to the user on the display 106.

Though the descriptions above include clothing properties the properties of any object in the image may also be used in a similar fashion. For example, the processor 102, may extract the color or type of flowers in an image and associate properties of the objects with event attributes in the event profile.

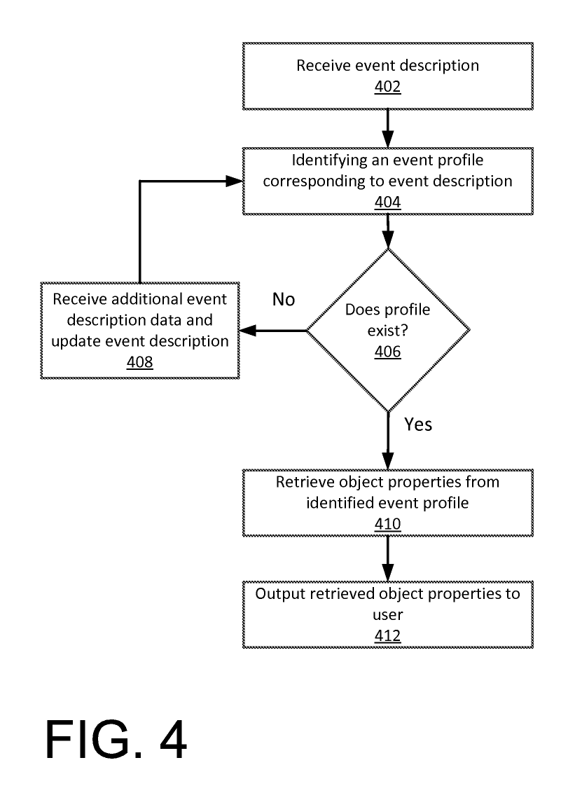

In this regard, FIG. 4 illustrates another exemplary method of operation of the system 100 (of FIG. 1) that outputs object properties as recommendations to a user for an event. In this regard, in block 402, an event description is received by the processor 102. The event description may include, for example, a description of the type of event, the time, and location of the event. The event description may be, for example, entered by the user using the input device 108 or another user device connected to the processor 102 via the network 110. In block 404, the processor 102 searches for an event profile in the memory 104 that corresponds, matches, or is similar to the received event description. Various search algorithms or methods may be used to identify one or more event profiles that match the event description. In some exemplary embodiments, in block 406, the processor may determine whether an event profile exits. If no, the processor 102 may request additional event description data from the user, and may update the event description in block 408. If yes, the object properties are retrieved from the event profile 410. In block 412, the object properties in the identified event profile are output to the user on the display 106.

The methods and systems described herein provide a user with recommendations for attire when the user inputs details about an event. The information may be used to plan a particular event, or to help a user determine suitable attire for a future event.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating event profiles, the method comprising:
receiving source data in a processor;
extracting an attire property from the source data;
extracting an event attribute from the source data;
associating the attire property with the event attribute;
generating an event profile that includes the associated attire property and the event attribute; and
saving the event profile in a memory.

2. The method of claim 1, wherein the source data includes an image.

3. The method of claim 1, wherein the source data includes a video.

4. The method of claim 1, wherein an attire property includes a description of attire present in the source data.

5. The method of claim 1, wherein the attire property is extracted from the source data using an attire recognition process.

6. The method of claim 1, wherein an event attribute includes a description of the event.

7. The method of claim 1, wherein the event attribute includes a geographic location of the event.

8. A method for providing attire recommendations, the method comprising:
receiving an event description from a user;
identifying an event profile corresponding to the event description;
retrieving attire properties from the identified event profile; and
outputting the retrieved attire properties to the user.

9. The method of claim 8, further comprising receiving additional event description data and updating the event description with the additional event description data responsive to failing to identify an event profile corresponding to the event description.

10. The method of claim 8, wherein the event description includes an event attribute including a geographic location of the event.

11. The method of claim 8, wherein the event description includes an event attribute including a description of the venue of the event.

12. The method of claim 8, wherein the event description includes a geographic location of the event.

13. The method of claim 8, wherein the event description includes an event attribute including a time of the event.

14. The method of claim 8, wherein the attire properties include a description of clothing.

15. The method of claim 8, wherein the attire properties include a description of clothing accessories.

16. The method of claim 8, further comprising:
retrieving object properties from the identified event profile; and
outputting the retrieved object properties to the user.

17. A computer program product comprising a computer readable storage medium having program instructions embodied therewith, the program instructions executable by a processor to cause the processor to perform a method comprising:
receiving source data in a processor;
extracting an attire property from the source data;
extracting an event attribute from the source data;
associating the attire property with the event attribute;
generating an event profile that includes the associated attire property and the event attribute; and
saving the event profile in a memory.

18. The method of claim 17, wherein the source data includes an image.

19. The method of claim 17, wherein the source data includes a video.

20. The method of claim 17, wherein an attire property includes a description of attire present in the source data.
